(19) United States
(12) Patent Application Publication
(10) Pub. No.: US 2002/0008610 A1
(43) Pub. Date: Jan. 24, 2002

(54) Key fob with slidable cover

(75) Inventor: John Peterson, Toronto (CA)

Correspondence Address: Dennison Associates, Suite 301, 133 Richmond Street West, Toronto, Ontario, M5H 2L7, CA

(73) Assignee: DIGITAL SECURITY CONTROLS LTD.

(21) Appl. No.: 09/780,401

(22) Filed: Feb. 12, 2001

(30) Foreign Application Priority Data
Jul. 21, 2000 (CA) 2,314,204

(51) Int. Cl. H04Q 1/00; G06F 7/00

(52) U.S. Cl. 340/5.64; 455/347; 340/693.6; 340/5.62

(57) ABSTRACT

A wireless key fob includes a slidable shield which is movable from an open position exposing a plurality of actuation keys to a closed position protecting the actuation keys. The shield is movable on the top surface of the key fob and preferrably automatically releasably locks when moved to the open or closed position. The shield is preferrably always located within the top surface to avoid stripping of the shield from the key fob. The slidable shield avoids accidental activation of the keys and increases battery life.

### FIELD OF THE INVENTION

The present invention relates to wireless remote control devices and in particular, relates to wireless key fobs.

### BACKGROUND OF THE INVENTION

Wireless key fobs are now used in many applications, including home security, car security and garage door opening applications. These key fobs are relatively small in size and have a limited number of keys on the top surface thereof which allow arming and disarming of the system, as well as other specific features, according to the application. For example, in a car security application, there is often an actuator for the trunk release and a panic button.

These devices typically are attachable to a key ring and are carried in a pocket or a purse. Unfortunately, accidental activation of the device can occur and this accidental activation is not always recognized by the user. This possibility comprises the security of the system when the accidental activation occurs near the security system and although not as serious, reduces the expected battery life when this accidental activation occurs at a significant distance from the system.

There have been attempts to solve this problem which can also occur with cellular telephones. Some cellular telephones include a flip cover which is hinged along one edge and movable from a closed position covering the keys to a fully open position where the keys are exposed. This type of design exposes the cover to substantial forces and damage to the hinge cover is a significant problem. Furthermore, in a key fob, this type of arrangement may be difficult to open and close by the user.

U.S. Pat. No. 5,388,691 discloses a specialized box in which a key fob is inserted. This structure has very significant draw backs due to possible contamination and is not a practical solution.

U.S. Pat. No. 5,678,204 discloses a hinged protective cover which has to be applied over a remote control actuator, however, this solution is not particularly satisfactory.

The present invention provides a simple effective solution for the above problems and provides a structure which is easy to use.

### SUMMARY OF THE INVENTION

A key fob according to the present invention, comprises a housing enclosing electrical components and a battery supply with a plurality of actuation keys exposed in ports of the housing. The housing has a top surface with said plurality of keys exposed in one area of the top surface. The key fob includes a slidable shield attached to the housing and movable from a closed position covering the actuation keys to an open position where the keys are exposed for actuation. The shield in the open position is located on the top surface.

In a preferred embodiment of the invention, the keys are located in a recessed area of the top surface.

According to a further aspect of the invention, the actuation keys are marginally below the top surface and the stop surface is generally rectangular in top view.

In yet a further aspect of the invention, the top surface is slightly curved across the width thereof and the curve is generally consistent in the length of the top surface.

In yet a further aspect of the invention, the shield is movable across the top surface and in the closed position, only a limited stripped border area of the top surface is exposed between the actuation keys and the lower edge of the key fob, and in the open position, only a limited strip border area at the top surface is exposed between the shield and the top edge of the key fob. With this structure, the shield is always within and does not extend beyond the ends of the top surface.

In yet a further aspect of the invention, the shield covers at least 40% of the top surface.

In yet a further aspect of the invention, the key fob has at least four actuation keys.

In yet a further aspect of the invention, the housing on opposed sides thereof include two slide tracks which cooperate with said shield member to retain said shield member on the key fob and accommodate the sliding movement of the shield between the open and the closed position.

In yet a further aspect of the invention, each slide track is an elongate recess and the shield member includes on each side thereof, inwardly extending slide members which are received and retained in the elongate recesses.

In yet a further aspect of the invention, each slide track and the respective slide member cooperate to retain the shield member in the open and closed position.

In yet a further aspect of the invention, this retention of the shield member in the open and closed position is accomplished by the shield locking with locking lugs provided along the track and the slides include recesses for receiving these locking members.

In yet a further aspect of the invention, the key fob housing is defined by a horizontally split housing with one piece of the split housing defining a top portion of the key fob and a second piece of the housing defining the bottom of the key fob. The slide track is collectively defined by the cooperating pieces of the housing. Basically one piece of the housing is recessed to define the track and the second piece of the housing closes the slide track along one edge thereof.

In yet a further aspect of the invention, the shield member includes a generally curved top surface and the shield member has a snap fit slide relationship with the housing.

In yet a further aspect of the invention, the slide track on the opposite sides of the housing are closed at the ends thereof and the shield member includes downwardly and inwardly extending slide members which are received and retained in said slide tracks.

### BRIEF DESCRIPTION OF THE DRAWINGS

Preferred embodiments of the invention are shown in the drawings, wherein:

FIG. 1 is a perspective view of the key fob with the shield member in an open position exposing the keys;

FIG. 2 is a perspective view similar to FIG. 1 with the shield member in the closed position covering the keys;

FIG. 3 is a side perspective view of the key fob showing details of the slide track;

FIG. 4 is a perspective view showing one slide member of the shield; and

FIG. 5 is an exploded perspective view of the key fob housing and shield member together with the electrical components and actuators contained in the key fob.

### DETAILED DESCRIPTION OF THE PREFERRED EMBODIMENTS

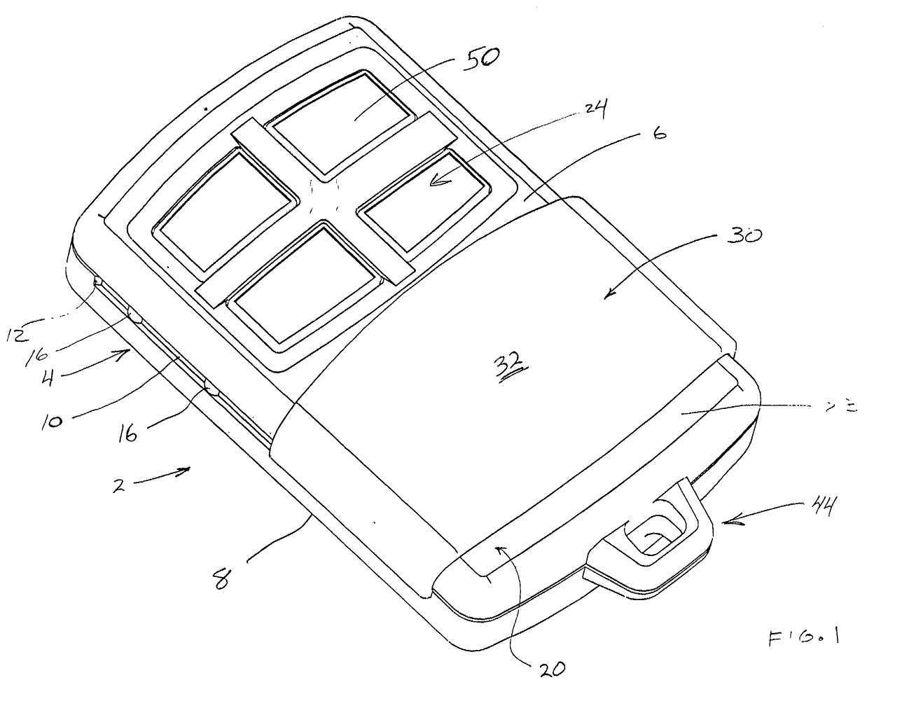

FIG. 1 shows a perspective view of the key fob housing and slidable shield member. The key fob 2 includes a housing 4 which is a horizontally split housing having a top casing 6 and a bottom casing 8. The housing includes slide tracks or recesses 10 located on opposite sides of the housing. The slide tracks 10 have closed ends 12 and thus, the slide tracks are located within the sides of the housing.

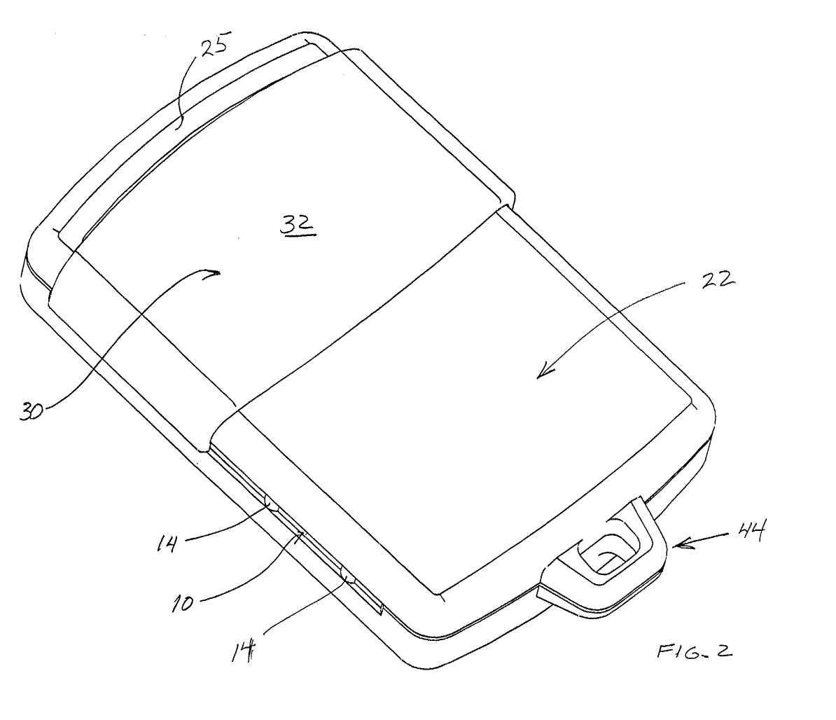

The slidable shield 30 moves from the open position shown in FIG. 1 with the actuation key portion 24 exposed to the closed position with the actuation keys 50 of the key fob covered as shown in FIG. 2. As can be appreciated from FIGS. 1 and 2, the shield member is captured on the top surface 20 of the key fob and either covers the key portion 24 of the top surface or covers the closed portion 22 of the top casing 6. The top surface 20 of the key fob is gently curved from side to side and this curve is generally consistent across the length of the key fob with the exception of the key portion 24. The slidable shield covers approximately 40 percent of the top surface. In the open position of FIG. 1, a thin strip region 23 is exposed at one end of the top surface. In the closed position, a thin strip region 25 is exposed between the shield and the other end of the top surface.

The top casing and the bottom casing each include a projecting portion which collectively define the fixed ported clasp 44 for receiving a key ring. The key fob housing is made of an injection molded plastic and the fact that each of the casings include a projection to collectively define the fixed ported clasp 44 adds to the strength of the clasp.

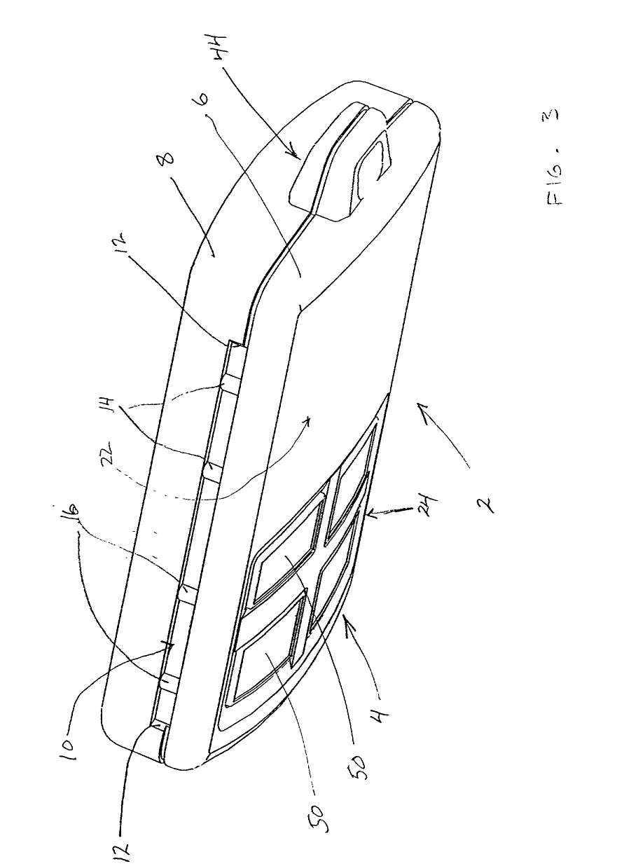

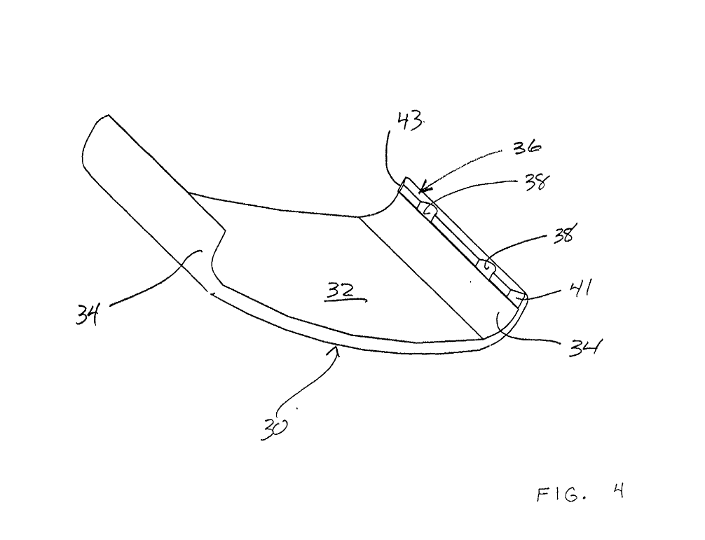

FIG. 3 shows details of the slide track 10 which is mostly defined at upper edges of the sides of the bottom casing 8. As can be seen, the bottom casing has been recessed along opposite sides of the housing to define the slide track. The slide track has molded therein, lower stop lugs 14 and upper stop lugs 16. The spacing between the lower lugs and the spacing between the upper lugs is the same and cooperate to engage the recesses 38 provided in the slide of the shield member 30 shown in FIG. 4.

The spacing between the adjacent lower stop lug and upper stop lug is larger than the spacing between stop lug pairs and therefore, only one of these lugs can engage a recess of the respective slide member at any point in time, as the slide member is moved between the open and closed position. In the closed position, stop lugs 16 engage the respective recesses 38 of each slide portion 36 and in the open position stop lugs 14 engage these recesses 38. As can be seen, the stop lugs include a curved leading edge and a curved trailing edge to assist in movement of the shield member past these lugs. In addition, the slide 38 has been provided with a sloped cam surface 41 at one end thereof and a sloped cam surface 43 at the opposite end of each slide portion.

Members 41 and 43 allow movement of the shield across the lugs 14 or 16 with the shield member distorting outwardly. The shield member 30 is made of an injection molded plastic and has a slightly curved upper surface 32 with opposed side portions 34. The curved upper surface 32 allows some flexing outwardly of the side portions 34 and allows movement of the slide members 36 across these stop lugs. As can be appreciated, when the recesses 38 align with an appropriate pair of stop lugs, it will provide retention of the shield member on the casing as the slides will engage the bottom of the track as opposed to the slides riding on the stop lugs. The receipt of upper stop lugs 16 in recesses 38 define the open position and the receipt of stop lugs 14 in recesses 38 define the closed position.

For a user to move the shield member 30 from the closed position of FIG. 2 to the open position of FIG. 1, the user presses on the top surface of the shield member with a downward and rearward force which can be exerted by the thumb of the user. This action provides some outward flexing of the shield member 30 reducing the force necessary for the recesses 38 to move past the stop lugs 16. As the shield member 30 is moved towards the open position, the cam surfaces 41 will strike the stop lugs 14 and allow camming thereover. The shield first flexes to cam over the first stop member 14 and then encounters the second stop member and flexes again. With this arrangement, the slide portions 36 are basically riding on the stop members and in the open or closed position, the slide members engage the bottom of the slide track and/or the recesses 38 seat on the stop members. This provides a very positive locating of the shield member in either the open or closed position. In addition, the shield member strikes the end of the track and thus, provides a further force limiting the extent to which the shield member can move on the key fob.

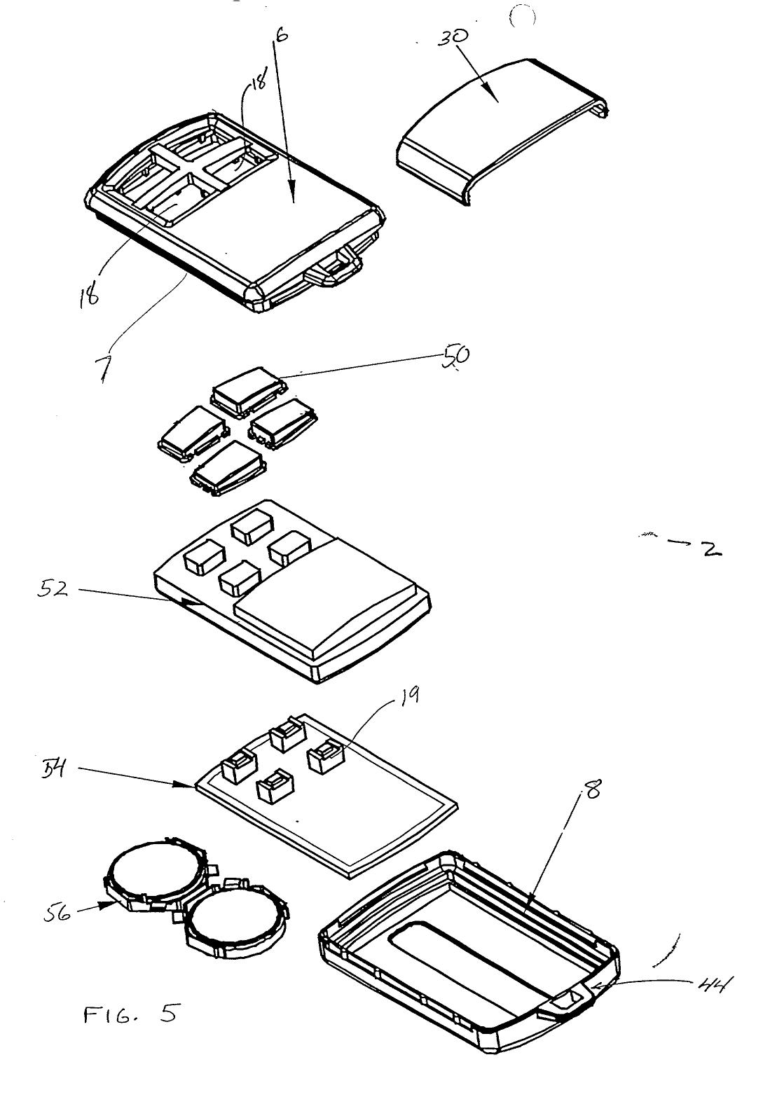

The flexing of the shield member is also used to secure the shield member on the key fob. As can be appreciated, the key fob housing can be assembled as generally shown in FIG. 3 with various electrical components shown in FIG. 5 contained within the key fob housing. The shield member is then appropriately positioned over the top surface and pressed downwardly. The side portions 34 of the shield member will flex outwardly and the slide portions 36 will cam over the outside curved edge of the casing until the slide portions snap into the slide tracks 10.

It is noted that the shield member as well as the top casing 6 have a slightly curved or arced upper surface and both of these members can flex when a downward thumb pressure is centrally exerted on the shield member. The side portions of the shield flex outwardly to reduce the engagement force between the shield member and the slide tracks. The flexing of the top surface merely causes a bowing of the top surface to allow flexing of the shield. Thus, very positive locking in both the closed and the open positions is achieved when this downward force is not present, yet the shield member is easily moved by the user between the open and the closed position. This results in a shield which when moved to the closed position, positively covers the actuation keys and is positively maintained in the closed position. The top surface of the shield member can be textured or ribbed to increase the grip between a user's thumb or fingers and the shield. The textured surface can also provide as a visual indication of how to shift the shield.

FIG. 5 is an exploded perspective view of the various components of the key fob. The key fob 2 includes the slidable shield 30 which cooperates with the top casing 6, as well as the bottom casing 8, and provides protection for the actuation buttons 50 which are located in the key ports 18. In this case, four key ports 18 are provided. The actuation buttons 50 and the key ports 18 arte each of a unique size, such that it is not possible to insert the actuation button of one port in any of the other ports. Interior to the key fob are two batteries 56 which are placed in the bottom casing 8 and provide power for the printed circuit board 54. A key mat 52 is placed over the printed circuit board and over the actuation switches 19 provided on the printed circuit board. Actuator buttons 50 are located between the key mat 52 and the interior surface of the top cover 6. The actuation keys can be push keys or other types of keys such as capacitance keys

In the assembled unit, the actuator buttons 50 are located below the top surface 20 of the key fob and in particular, are located below the lower surface of the slidable shield member 30.

FIG. 5 also shows how the top casing 6 includes a slightly projecting flange along the sides thereof which closes each slide track along one side of the slide track when the casing 6 is received and engages the bottom casing 8. In this way, the bottom casing 8 is recessed to define the slide track and the slide track is closed on one edge thereon by the projecting flange 7 of the top casing 6. This simplifies the mold design for the bottom casing and avoids difficult undercut portions. Preferrably, the top casing and bottom cashing cooperate in a snap fit retention arrangement.

With the key fob, the slidable shield is movable across the top surface of the key fob from a closed position covering the actuation keys to a fully exposed position where the actuators are readily accessible. This movement between the open and closed position is performed by the thumb, or finger pressure on the upper surface of the shield member outwardly flexing the shield member and urging the shield member towards the desired open or closed position. The slide member also locks with the key fob casing in either the open or closed position and thus, inadvertent movement of the shield member between these positions is avoided.

This structure provides maximum protection of the keys by preventing unwanted contact with other objects and thus accidental actuation of the key fob is essentially avoided. The structure is quite simple. It does not appreciably increase the size of the key fob and is less prone to damage than earlier proposed structures. The battery life of the key fob is also increased in that accidental unwanted transmissions are avoided.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A key fob comprising a housing enclosing electrical components and a battery supply with a plurality of actuation keys exposed in parts of said housing, said housing having a top surface with said plurality of keys in a key area of said top surface, said key fob further including a slidable shield attached to said housing and movable from a closed position covering said actuation keys to an open position where said keys are exposed for actuation, said shield in said open position being located on said top surface.

2. A key fob as claimed in claim 1 wherein said keys are located in a recessed area of said top surface.

3. A key fob as claimed in claim 1 wherein said actuation keys are marginally below said top surface and said top surface is generally rectangular in top view.

4. A key fob as claimed in claim 1 wherein said top surface has an area adjacent said key area and at least equal in size to said area such that said shield in said open position overlies said adjacent area.

5. A key fob as claimed in claim 3 wherein said top surface is slightly curved across the width thereof and said curve is consistent in the length of the top surface.

6. A key fob as claimed in claim 1 wherein shield is movable across said top surface and in said closed position only a limited strip border area of said top surface is exposed between said actuation keys and a lower edge of said key fob and in said open position only a limited strip border area of said top surface is exposed between said shield and a top edge of said key fob.

7. A key fob as claimed in claim 6 wherein said covers at least 40% of said to surface.

8. A key fob as claimed in claim 7 wherein said plurality of keys include at least 4 keys.

9. A key fob as claimed in claim 1 wherein said housing on opposed sides thereof includes two slide tracks which cooperate with said shield member to retain said shield member on said key fob and accommodate the sliding movement of said shield between said open and said closed position.

10. A key fob as claimed in claim 9 wherein each slide track is an elongate recess and said shield member includes on each side thereof inwardly extending slide members which are received and retained in said elongate recesses.

11. A key fob as claimed in claim 10 wherein said each slide track and the respective slide member cooperate to retain said shield member in said open or closed position.

12. A key fob as claimed in claim 11 wherein said shield member has a gently curved upper surface and opposed side portions which extend downwardly and include said slide members.

13. A key fob as claimed in claim 12 wherein said gently curved upper surface of said shield member allows resilient flexing of said shield member and during flexing said side portions flex outwardly.

14. A key fob as claimed in claim 13 wherein said slide tracks include stationary cam members and said slide members when forced over said cam members cause said shield member to flex with said side portions moving outwardly.

15. A key fob as claimed in claim 14 wherein said cam members cooperate with recesses in said slide members to releasably lock said shield member in said open or closed position.

16. A key fob as claimed in claim 15 wherein each slide track includes 4 cam members and each slide member includes 2 recesses positioned for receiving 2 cam members in said open position and a different 2 cam members in the closed position.

17. A key fob as claimed in claim 9 wherein said housing is a two piece horizontally split housing with one piece of said split housing at an edge thereof having two top opening recesses either side of said key fob which are closed by the other housing and collectively form said slide tracks.

18. A key fob as claimed in claim 17 wherein said housing and said shield member are injection molded plastic.

19. A key fob as claimed in claim 1 wherein said shield member cooperates with said housing and includes a releasable lock arrangement maintaining said shield member in the closed position until released by a downward and forward force urging said shield member to move towards the open position.

20. A key fob as claimed in claim 19 wherein both said housing and said shield member include a gently curved top surface and said shield member has a snap fit slide relationship with said housing.

21. A key fob as claimed in claim 20 wherein said housing includes slide tracks on opposite sides of said housing which are closed at the ends thereof and said shield member includes downwardly and inwardly extending slide members which are received and retained in said slide tracks.
